(19) United States
(12) Patent Application Publication
(10) Pub. No.: US 2018/0189344 A1
(43) Pub. Date: Jul. 5, 2018

(54) ONBOARDING PORTAL FOR CLOUD PLATFORM

(71) Applicant: General Electric Company, Schenectady, NY (US)

(72) Inventors: Melanie AKWULE, San Ramon, CA (US); Susan NATHAN, San Ramon, CA (US); Partha DEKA, San Ramon, CA (US); Spencer HUANG, San Ramon, CA (US); Vikram LAKSHMIPATHY, San Ramon, CA (US)

(21) Appl. No.: 15/394,955

(22) Filed: Dec. 30, 2016

(51) Int. Cl. G06F 17/30

(52) U.S. Cl. CPC G06F 17/30371; G06F 3/0482; G06F 17/30873; G06F 17/30864

(57) ABSTRACT

The example embodiments are directed to an onboarding portal for adding a new IoT software item to a cloud platform. In an example, a web service of the cloud platform may receive a plurality of user inputs associated with an IoT analytic application input via an onboarding user interface. Meanwhile, a workflow engine of the cloud platform may distribute the plurality of user inputs to a plurality of workstations for verifying the plurality of user inputs, receive status notifications indicating whether the user inputs have been successfully verified, and output the status notifications to a user device associated with the IoT analytic application. The web service and the workflow engine provide an end-to-end communication between a user portal and a cloud computing environment making it possible to efficiently test and subsequently add an IoT application to the cloud platform.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include healthcare machines and equipment that aid in diagnosing patients such as imaging devices (e.g., X-ray or MRI systems), monitoring devices, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

One of the difficulties in designing a computing platform that supports machine and equipment focused resources such as software, data, and services, is the amount and the variety of resources that may be of interest to a user through the platform. For example, a power plant user or operator may be interested in viewing and interacting with applications and data related to the plant in order to manage/view attributes such as generators, cooling towers, a plant floor, materials, alerts, fuel usage, power protection, power distribution, control systems, and/or the like. As another example, an aircraft operator may be interested in viewing and interacting with applications and data related to an aircraft such as weather forecasting systems, historical flight information systems, fuel consumption data, cargo data, and the like.

However, the cloud based resources that are deployed on the cloud platform may be created by different vendors using different programming languages and different raw data. As a result, the resources may accept a wide array of inputs, generate different outputs, have different operational characteristics, and the like. Furthermore, each resource must be able to operate with other resources that are or that may eventually be stored on the cloud platform. Accordingly, what is needed is a way of onboarding resources to a cloud platform to ensure that the resources operate satisfactorily.

### SUMMARY

In an aspect of an example embodiment, there is provided a method for onboarding an Internet of Things (IoT) application to a cloud platform, the method including receiving, by a web service of the cloud platform, a plurality of user inputs associated with an IoT analytic application from an onboarding user interface, distributing, by a workflow engine of the cloud platform, the plurality of user inputs to a plurality of workstations for verifying the plurality of user inputs, receiving, by the workflow engine, status notifications indicating whether the user inputs have been successfully verified, and outputting, by the workflow engine, the status notifications to a user device associated with the IoT analytic application.

In an aspect of another example embodiment, there is provided a cloud computing device for onboarding an Internet of Things (IoT) application to a cloud platform, the cloud computing device including a web service configured to receive a plurality of user inputs associated with an IoT analytic application input via an onboarding user interface, and a workflow engine configured to distribute the plurality of user inputs to a plurality of workstations for verifying the plurality of user inputs, receive status notifications indicating whether the user inputs have been successfully verified, and output the status notifications to a user device associated with the IoT analytic application.

In an aspect of another example embodiment, there is provided a non-transitory computer readable medium having stored therein instructions that when executed cause a computer to perform a method for onboarding an Internet of Things (IoT) application to a cloud platform, the method including receiving, by a web service of the cloud platform, a plurality of user inputs associated with an IoT analytic application from an onboarding user interface, distributing, by a workflow engine of the cloud platform, the plurality of user inputs to a plurality of workstations for verifying the plurality of user inputs, receiving, by the workflow engine, status notifications indicating whether the user inputs have been successfully verified, and outputting, by the workflow engine, the status notifications to a user device associated with the IoT analytic application.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment associated with industrial systems in accordance with an example embodiment.

FIG. 2A is a diagram illustrating an onboarding system for a cloud computing environment in accordance with an example embodiment.

FIG. 2B is a diagram illustrating an example of a user interface for onboarding in accordance with an example embodiment.

FIG. 3 is a diagram illustrating phases and inputs for the onboarding process of the cloud platform, in accordance with an example embodiment.

FIG. 4 is a diagram illustrating a method for onboarding an IoT application to a cloud platform in accordance with example embodiments.

FIG. 5 is a diagram illustrating a device for onboarding an Internet of Things IoT application to a cloud platform in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to an onboarding portal and system for a cloud computing platform configured to onboard resources being published on the cloud platform. The cloud platform may be used to host the resources (e.g., applications, services, data, etc.) associated with an Internet of Things (IoT) or an Industrial IoT (IIot). The resources may be added to a common environment and made accessible to users of the platform. The onboarding system may provide a portal which may be displayed on a computing device of a user/developer. The user may input information at various stages of the onboarding process with respect to the resource being onboarded. The inputs may be stored in a front-end database. A web service of the cloud platform may query the database for the input resource information when the user desires to deploy the resource on the cloud platform. The inputs may be transferred to a workflow engine of the cloud platform via the web service. According to various embodiments, the web service operates between the user portal and the workflow engine and is designed to expand communication capabilities of the workflow engine. The web service may manage data communication between the user portal and the cloud platform and enable seamless interaction between the two.

The workflow engine may receive the inputs associated with the resource from the web service. In response, the workflow engine may generate an identification of the resource to uniquely identify the resource and provide the identification to the user and the web service for tracking a progress of the resource as it goes through the onboarding process. The workflow engine may also distribute the input information to stakeholders for testing various inputs at various phases of the onboarding process. Each stakeholder may be associated with a particular phase of the onboarding process and may determine whether a respective input satisfies a predetermined threshold for the respective phase. Also, the stakeholder may provide a notification to the workflow engine indicating whether the input has passed the respective phase of the onboarding process. Each time an input is successfully verified, the workflow engine may provide a notification to the user/developer and also move the onboarding workflow to the next phase of the onboarding process.

As mentioned above, the onboarding process may be directed towards items being published on a cloud platform related to an Industrial Internet of Things. While progress with machine and equipment automation has been made over the last several decades, and assets have become ‘smarter,’ the intelligence of any individual asset pales in comparison to intelligence that can be gained when multiple smart devices are connected together, for example, in the cloud. Assets may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

For example, an asset can be outfitted with one or more sensors configured to monitor respective operations or conditions. Data from the sensors can be added to the cloud platform. By bringing such data into a cloud-based environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like. Examples of the software applications are described herein as analytics. Analytics may be used to analyze, evaluate, and further understand issues related to manufacturing. Prior to becoming operational, the example embodiments may implement an onboarding process on the data and the applications before they are accessible within the cloud platform. The onboarding process may be used to verify the applications perform as expected, verify that the applications work with other applications and data on the platform, identify support requested by the applications, and the like.

The assets can include or can be a portion of an Industrial Internet of Things (IIoT). In an example, an IIoT connects assets including machines and equipment, such as turbines, jet engines, healthcare machines, locomotives, and the like, to the Internet or cloud, or to each other in some meaningful way such as through one or more networks. The systems and methods described herein can include using a “cloud” or remote or distributed computing resource or service. The cloud can be used to receive, relay, transmit, store, analyze, or otherwise process information for or about one or more assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

However, the integration of assets with the remote computing resources to enable the IIoT often presents technical challenges separate and distinct from the specific industry and from computer networks, generally. A given machine or equipment based asset may need to be configured with novel interfaces and communication protocols to send and receive data to and from distributed computing resources. Given assets may have strict requirements for cost, weight, security, performance, signal interference, and the like such that enabling such an interface is rarely as simple as combining the asset with a general purpose computing device. To address these problems and other problems resulting from the intersection of certain industrial fields and the IIoT, embodiments provide a cloud platform that can receive and host applications from many different fields of industrial technologies. In order to successfully host these applications, the embodiments provide an onboarding process that tests/verifies an application, as well as other functions, before the application is added to the cloud platform.

The Predix™ platform available from GE is a novel embodiment of an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of assets can be uniquely situated to leverage its understanding of assets themselves, models of such assets, and industrial operations or applications of such assets, to create new value for industrial customers through asset insights.

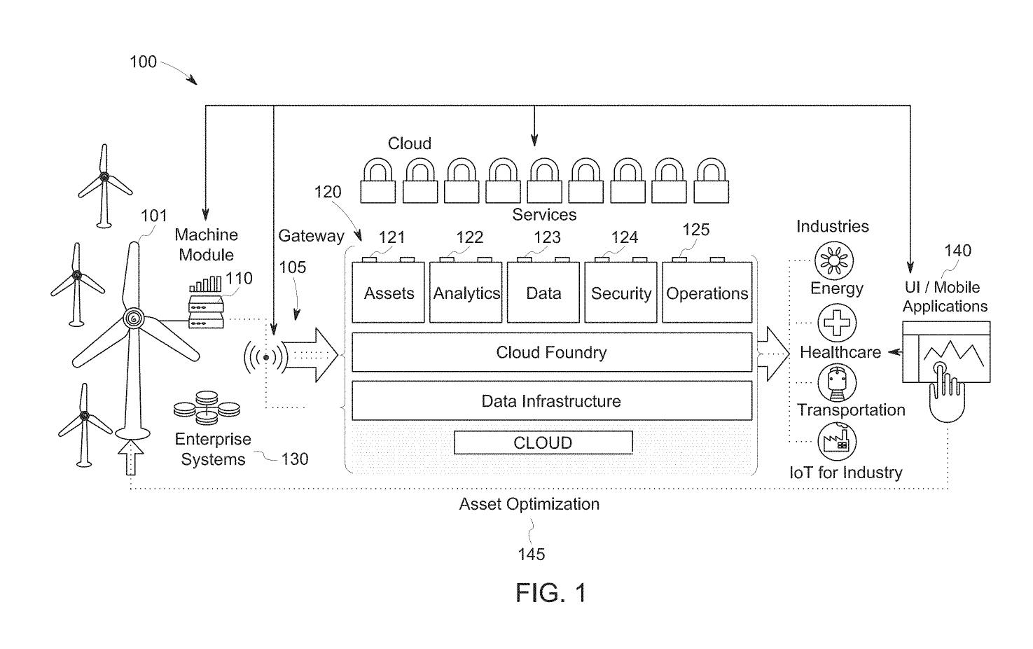

FIG. 1 illustrates a cloud computing environment associated with industrial systems in accordance with an example embodiment. FIG. 1 illustrates generally an example of portions of an asset management platform (AMP) 100. As further described herein, one or more portions of an AMP can reside in a cloud computing system 120, in a local or sandboxed environment, or can be distributed across multiple locations or devices. The AMP 100 can be configured to perform any one or more of data acquisition, data analysis, or data exchange with local or remote assets, or with other task-specific processing devices. The AMP 100 includes an asset community (e.g., turbines, healthcare machines, industrial, manufacturing systems, etc.) that is communicatively coupled with the cloud computing system 120. In an example, a machine module 110 receives information from, or senses information about, at least one asset member of the asset community, and configures the received information for exchange with the cloud computing system 120. In an example, the machine module 110 is coupled to the cloud computing system 120 or to an enterprise computing system 130 via a communication gateway 105.

In an example, the communication gateway 105 includes or uses a wired or wireless communication channel that extends at least from the machine module 110 to the cloud computing system 120. The cloud computing system 120 may include several layers, for example, a data infrastructure layer, a cloud foundry layer, and modules for providing various functions. In the example of FIG. 1, the cloud computing system 120 includes an asset module 121, an analytics module 122, a data acquisition module 123, a data security module 124, and an operations module 125. Each of the modules includes or uses a dedicated circuit, or instructions for operating a general purpose processor circuit, to perform the respective functions. In an example, the modules 121-125 are communicatively coupled in the cloud computing system 120 such that information from one module can be shared with another. In an example, the modules 121-125 are co-located at a designated datacenter or other facility, or the modules 121-125 can be distributed across multiple different locations.

An interface device 140 (e.g., user device, workstation, tablet, laptop, appliance, kiosk, and the like) can be configured for data communication with one or more of the machine module 110, the gateway 105, and the cloud computing system 120. The interface device 140 can be used to monitor or control one or more assets. As another example, the interface device 140 may be used to develop and upload applications to the cloud computing system 120. As yet another example, the interface device 140 may be used to access analytical applications hosted by the cloud computing system 120. In an example, information about the asset community may be presented to an operator at the interface device 140. The information about the asset community may include information from the machine module 110, or the information can include information from the cloud computing system 120. The interface device 140 can include options for optimizing one or more members of the asset community based on analytics performed at the cloud computing system 120. Prior to analytics being accessed through the cloud computing system 120, the cloud computing system 120 may perform an onboarding process on the analytics before they are added to the platform, according to various embodiments.

A user of the interface device 140 may control an asset through the cloud computing system 120, for example, by selecting a parameter update for a first wind turbine 101. In this example, the parameter update may be pushed to the first wind turbine 101 via one or more of the cloud computing system 120, the gateway 105, and the machine module 110. In some examples, the interface device 140 is in data communication with the enterprise computing system 130 and the interface device 140 provides an operation with enterprise-wide data about the asset community in the context of other business or process data. For example, choices with respect to asset optimization can be presented to an operator in the context of available or forecasted raw material supplies or fuel costs. As another example, choices with respect to asset optimization can be presented to an operator in the context of a process flow to identify how efficiency gains or losses at one asset can impact other assets.

Returning again to the example of FIG. 1 some capabilities of the AMP 100 are illustrated. The example of FIG. 1 includes the asset community with multiple wind turbine assets, including the first wind turbine 101. However, it should be understood that wind turbines are merely used in this example as a non-limiting example of a type of asset that can be a part of, or in data communication with, the first AMP 100

FIG. 1 further includes the device gateway 105 configured to couple the asset community to the cloud computing system 120. The device gateway 105 can further couple the cloud computing system 120 to one or more other assets or asset communities, to the enterprise computing system 130, or to one or more other devices. The AMP 100 thus represents a scalable industrial solution that extends from a physical or virtual asset (e.g., the first wind turbine 101) to a remote cloud computing system 120. The cloud computing system 120 optionally includes a local, system, enterprise, or global computing infrastructure that can be optimized for industrial data workloads, secure data communication, and compliance with regulatory requirements.

The cloud computing system 120 can include the operations module 125. The operations module 125 can include services that developers can use to build or test Industrial Internet applications, and the operations module 125 can include services to implement Industrial Internet applications, such as in coordination with one or more other AMP modules. In an example, the operations module 125 includes a microservices marketplace where developers can publish their services and/or retrieve services from third parties. In addition, the operations module 125 can include a development framework for communicating with various available services or modules. The development framework can offer developers a consistent look and feel and a contextual user experience in web or mobile applications. Developers can add and make accessible their applications (services, data, analytics, etc.) via the cloud computing system 120.

Information from an asset, about the asset, or sensed by an asset itself may be communicated from the asset to the data acquisition module 123 in the cloud computing system 120. In an example, an external sensor can be used to sense information about a function of an asset, or to sense information about an environment condition at or near an asset. The external sensor can be configured for data communication with the device gateway 105 and the data acquisition module 123, and the cloud computing system 120 can be configured to use the sensor information in its analysis of one or more assets, such as using the analytics module 122. Using a result from the analytics module 122, an operational model can optionally be updated, such as for subsequent use in optimizing the first wind turbine 101 or one or more other assets, such as one or more assets in the same or different asset community. For example, information about the first wind turbine 101 can be analyzed at the cloud computing system 120 to inform selection of an operating parameter for a remotely located second wind turbine that belongs to a different asset community.

The cloud computing system 120 may include a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration can be useful when an application requires an underlying hardware configuration. The provisioning management and pooling of resources can be done at a granular level, thus allowing optimal resource allocation. In addition, the asset cloud computing system 120 may be based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The cloud computing system 120 can include a data services module that can facilitate application development. For example, the data services module can enable developers to bring data into the cloud computing system 120 and to make such data available for various applications, such as applications that execute at the cloud, at a machine module, or at an asset or other location. In an example, the data services module can be configured to cleanse, merge, or map data before ultimately storing it in an appropriate data store, for example, at the cloud computing system 120. A special emphasis may be placed on time series data, as it is the data format that most sensors use.

Security can be a concern for data services that exchange data between the cloud computing system 120 and one or more assets or other components. Some options for securing data transmissions include using Virtual Private Networks (VPN) or an SSL/TLS model. In an example, the AMP 100 can support two-way TLS, such as between a machine module and the security module 124. In an example, two-way TLS may not be supported, and the security module 124 can treat client devices as OAuth users. For example, the security module 124 can allow enrollment of an asset (or other device) as an OAuth client and transparently use OAuth access tokens to send data to protected endpoints.

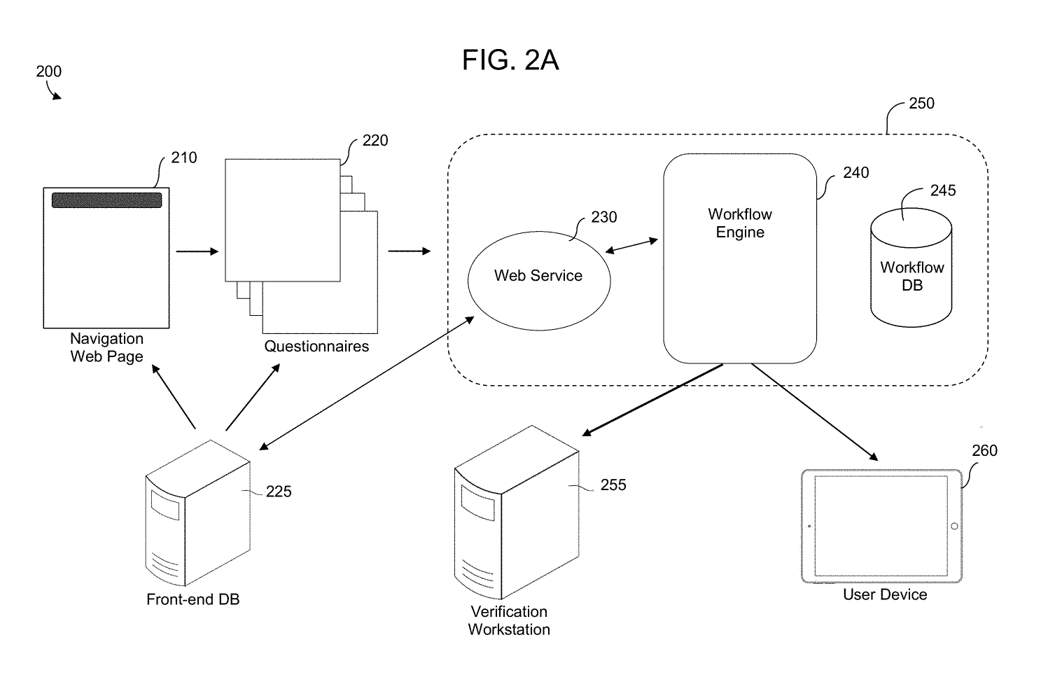

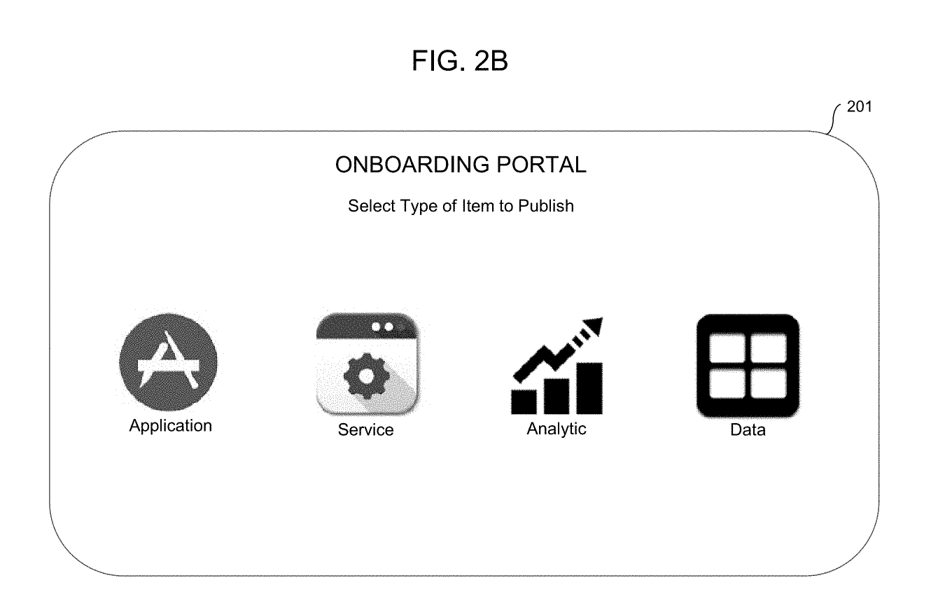

FIG. 2A illustrates an onboarding system 200 for a cloud computing environment in accordance with an example embodiment. The diagram of FIG. 2A represents an example flow of data through the system 200 beginning with a navigation web page or pages 210 to a workflow engine 240 hosted on a cloud platform 250. A user (e.g., a partner, client, etc.) that desires to onboard a new resource to the platform, would start by accessing the navigation web pages 210 via a web browser stored on a computing device. The navigation pages 210 may be hosted by a server 225 and allow the user to login and be directed to a navigation page where they can view a dashboard of their previously uploaded resources and/or submit a new resource for onboarding. The dashboard allows the user to see all resources currently within the onboarding process and which stage/phase is currently processing the resource, or if the onboarding has been completed. The resource being onboarded to the platform may be a service, an application, data, and the like. The resources may be associated with an Internet of Things environment or an Industrial Internet of Things environment.

When the user submits a new resource, the submission creates a new process instance within workflow engine 240. According to various aspects, the workflow engine 240 may be a business process management application, for example, Activiti, and the like. The workflow engine 240 may be a process engine for JAVA, and may run in a JAVA application, on a server, on a cluster in the cloud, and the like. The workflow engine may include or may be part of a process virtual machine (PVM) which is an architecture design pattern for process engines. The structure of the process may be separated from the implementation of the different activity types and the runtime data structure for process executions may be based on a pointer to an activity in the process graph. Activity types and hence whole process languages may become pluggable on that single core engine.

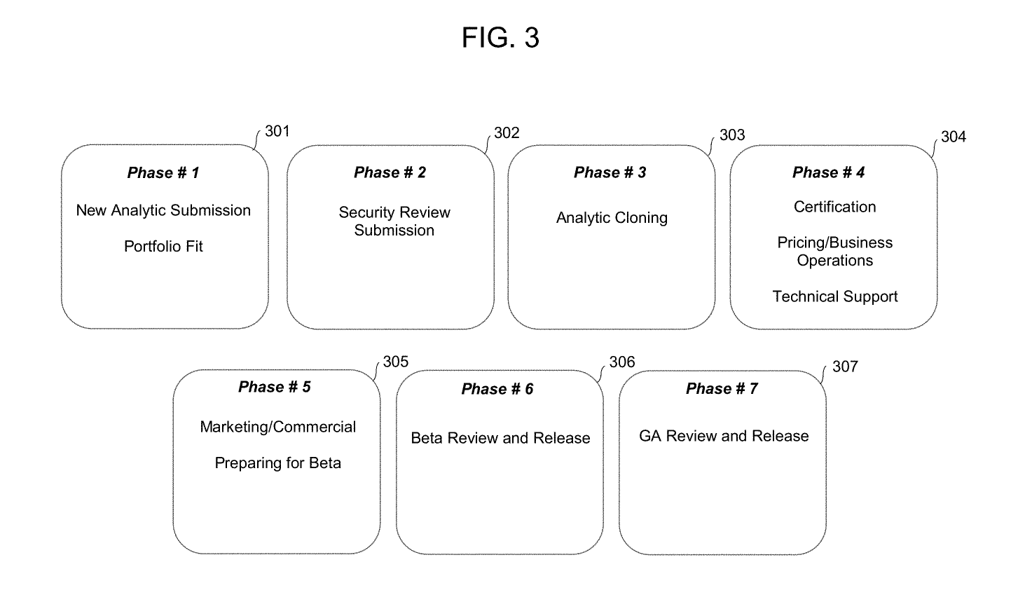

Once a user decides to submit a new resource to the cloud platform, the web page directs the user to one or more questionnaires 220 such as shown in FIG. 3. The questionnaires 220 may be used at each phase of the onboarding process to elicit different responses (text, images, tables, data), materials, code, packages, expected outputs, and the like, from the user with respect to the resource being added. Each stage of the onboarding process may be assigned to a respective stakeholder of the cloud platform. The stakeholder may be user or an automated process capable of testing, verifying, approving, etc., the inputs provided by the user. Each questionnaire 220 collects data necessary for each stakeholder associated with a respective phase to complete their independent onboarding processes. Examples of the phases/questionnaires 220 include an initial package submission, security review, architecture and design verification, analytic handoff, marketing, pricing, technical support, and the like.

An administrative back-end, for example, LimeSurvey which is an open-source framework used as a template engine, or the like, may be used to maintain the questionnaire 220 templates and may also be hosted on the same server 225 as the navigation web pages 210. The user may manually enter text data and upload any multi-media data such as images and binary executables via each questionnaire. The template engine may persist the user inputs in a front-end database 225 once the data has been submitted per questionnaire, and simultaneously notify a web service 230. The web service 230 may be hosted by a web server and/or a cloud platform and enable communication between the workflow engine 240 and the navigation web pages 210 through the web. As one example, the web service 230 may be a representational state transfer (RESTful) web service that acts as an intermediary between the navigation web pages 210 and the workflow engine 240 as well as a remainder of the cloud platform 250. The web service 230 may receive a request such as a RESTful request from the navigation web pages asking for the web service 230 to take action on the newest input data.

For example, the web service 230 may receive Ajax RESTful calls as well as issue RESTful requests. The web service 230, which may be hosted by the cloud or an external device, may perform a database query to obtain the user inputs stored by the administrative back-end 225, prepare the user inputs received by the querying as an Ajax RESTful request in JSON format, and issue a request (e.g., RESTful API request) containing the prepared data. Upon receiving a valid response from workflow engine 240, the web service 230 may persist corresponding metadata regarding this process instance in the front-end database 225 or another storage device. In the example of a new resource submission questionnaire, once all the questionnaire data has been queried by the web service 230 and submitted to the workflow engine 240, the workflow engine 240 may return a process instance identification back to the web service 230. The process instance identification is a tracking number for this particular process instance as it traverses the business flow within the workflow engine 240. Upon receiving this identification, the web service 230 may persist this identification (e.g., number) as well as common attributes from the questionnaire at the front-end database 225.

After beginning a process instance within the workflow engine 240, notifications such as e-mails, SMS messages, and the like, may be sent to stakeholder workstations 255 defined for a particular phase of the onboarding process. For example, after the workflow engine 240 has created a process instance for the newest resource submission, the workflow engine 240 may notify all the stakeholders of the onboarding process via e-mail. Any stakeholder 255 listed within a team would be able to claim the process instance through the task associated to this new questionnaire submission. The task may also require the stakeholder 255 to log into the workflow engine 240 through a link included in the email in order to act on the phase. For example, through the workflow engine 240, a stakeholder 255 may approve or reject the onboarding of the resource based on the input submitted by the user via a questionnaire 220. FIG. 2A shows one stakeholder 255, but it should be appreciated that the system may include a plurality of stakeholders 255 each set for different respective stages of the onboarding process.

In some cases, before a stakeholder may take action within the workflow engine 240, the workflow engine 240 may first record the data forwarded from the web service 230 in its own database 245, mapping it to the corresponding process instance. Once the action for a task has been manually completed by a stakeholder, the workflow engine 240 may mark or otherwise flag this task associated with this process instance as complete. Then, based on a next phase or phases of the onboarding process, the workflow engine 240 may transition the process instance to the next task or phase, or wait for the next incoming task to be introduced by the web service 230. To enhance the user experience, the workflow engine 240 may transmit email notifications to a user device 260 notifying the user of each major milestone or phase that has been completed. For example, the emails may include customized uniform resource locators (URLs) that help guide the user throughout the process by directing them on which questionnaires to fill out when.

FIG. 2B illustrates a user interface 201 for onboarding resources to a cloud platform. The user interface 201 may be included within the navigation pages 210 shown in FIG. 2A. As shown in FIG. 2B, a plurality of different resources or items may be uploaded through the onboarding portal and may be selected through via the user interface 201. For example, an application, an analytic, data, a service, and the like may be selected. Here, a user may select one or more of these items for onboarding. That is, the user may onboard a single item or they may select multiple items to onboard to the cloud platform. When the user selects a particular item, the user interface 201 may navigate to a first phase of the onboarding process which includes a first set of questions/inputs. The user interface may navigate to additional phases of the onboarding process as the phases of the onboarding process are completed.

FIG. 3 illustrates examples of phases and corresponding inputs for the onboarding process of the cloud platform, in accordance with an example embodiment. In this example, a plurality of phases are shown and numbered as phases one through seven. However, it should be appreciated that no specific sequencing for performing the phases is required, one or more of the phases may be omitted, and one or more other phases may be added. A workflow engine may receive a request to begin a new onboarding process for a resource and execute the process on a phase-by-phase basis. During execution of a phase, the workflow engine may receive inputs for the phase from a web service, store the inputs, and provide the inputs to a respective stakeholder or stakeholders for processing the phase. Next, the workflow engine may receive a notification from the stakeholder indicating whether the phase was successfully completed and notify the user that the phase was successfully completed as well as provide a link or a URL to a next phase in the process.

As a non-limiting example, a first phase 301 may include a new analytic submission, and a portfolio fit process. During the new analytic submission, the user may access the onboarding portal to submit a new analytic for onboarding to a catalog of analytics of the cloud platform. During the portfolio fit process, the onboarding team (e.g., stakeholder) reviews the submission in the workflow engine and determines whether or not the analytic is a fit for the catalog portfolio of the cloud platform. Here, the onboarding team may determine whether to reject or approve the analytic and notify the user of the decision through a customized email created in the workflow engine.

A second phase 302 may include a security review submission. For example, the user may receive an approval email indicating that the first phase 301 is approved, and which directs the user to the portal to fill out a security review questionnaire. Once submitted, a security stakeholder/team may be notified within the workflow engine and may access and act upon the data submitted. In this example, the user is not dependent on a response or action from the security stakeholder and may continue with the process and may receive a customized confirmation email from the workflow engine with additional links to the next set of questionnaires and instructions.

A third phase 303 may include an analytic cloning process. Before submitting certification related questionnaires, the user may receive instructions by email on how to clone the analytic that is to be certified. A fourth phase 304 may include the certification process. Once the analytic has been cloned to a staging area, a certification stakeholder may perform a number of security tests and validation checks to ensure the fidelity of the analytic model. Submission of an analytic handoff and an architecture design document questionnaires may initiate the certification sub-process within the workflow engine triggered by the web service. The fourth phase 304 may also include submission of the pricing & licensing questionnaire which triggers a stakeholder by the workflow engine, and submission of a technical support questionnaire which automatically triggers another stakeholder by the workflow engine.

A fifth phase 305 may include a submission of an analytic questionnaire which automatically triggers an analytic stakeholder team sub-process in the workflow engine. Also, a submission of a marketing questionnaire may send the data for the new analytic to a commercial stakeholder/team through a notification task in the workflow engine. Once the analytic has been approved by the certification team, an engineering team may move the analytic from the staging environment in preparation for a beta review process. A sixth phase 306 includes a beta review and release process. The review stakeholder may review that all stakeholder teams have completed their onboarding activities via the stakeholder dashboard in the workflow engine. Also, the review stakeholder may prepare a ticket needed to present the analytic to a change advisory board in order for the analytic to be released as a beta tile on the cloud platform. Once the tile is approved to be released in beta, the workflow engine may send notifications to the commercial and tile teams with release details. In a seventh phase 307, the onboarding stakeholder team verifies that all stakeholder teams have completed their migration from beta to general activities via the stakeholder dashboard in the workflow engine. Once the tile is approved to be released in general, the onboarding team leverages the workflow engine to send notifications to the stakeholder teams with release details.

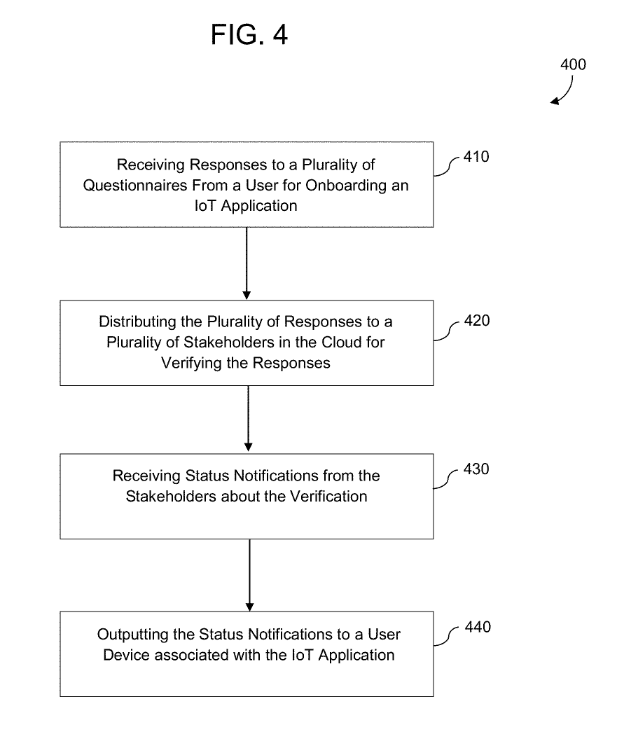

FIG. 4 illustrates a method 400 for onboarding an IoT application to a cloud platform in accordance with example embodiments. For example, the method 400 may be performed by a cloud platform, a server, a computing device, and the like. Referring to FIG. 4, in 410 the method includes receiving, by a web service of the cloud platform, a plurality of user inputs associated with an IoT analytic application from an onboarding user interface. For example, the plurality of user inputs may include one or more of textual data, images, spreadsheets, software, code, or other data, input or uploaded by the user via the onboarding user interface and which are associated with executing the IoT application. Here, the user inputs may be initially stored in a database and accessed by the web service querying the database for the stored information. The querying may be initiated in response to receiving a request from a web application associated with the onboarding user interface. In one example, the web service includes a RESTful web service. In this example, and the method may further include generating, by the web service, a RESTful application programming interface (API) request including the plurality of user inputs and issuing the RESTful API request to the workflow engine.

In 420, the method includes distributing, by a workflow engine of the cloud platform, the plurality of user inputs to a plurality of workstations for verifying the plurality of user inputs. Each of the workstations may correspond to a stakeholder associated with a respective phase of the onboarding process. Each stakeholder may verify or otherwise test a particular input regarding a particular phase and provide a notification to the workflow engine indicating whether the input satisfied the onboarding verification process. According to various aspects, the workflow engine may be a business process management platform stored on the cloud platform for managing business processes of the cloud platform. In response to receiving the user inputs, the workflow engine may generate a process instance identification (ID) uniquely identifying the IoT analytic application and transmitting the generated process ID to the web service. Here, the process ID may enable the web service to track a status of the onboarding process of the IoT analytic application.

In 430, the method includes receiving, by the workflow engine, status notifications indicating whether the user inputs have been successfully verified, and in 440, outputting the status notifications to a user device associated with the IoT analytic application. The status notifications may indicate that a first phase of the onboarding process associated with a first user input has been successfully verified, and the output sent to the user device may indicate that the first phase was successful and also include a link to a page for inputting user input associated with a second phase of the onboarding process. For example, the link may be configured to navigate a web browser of the user device to a page of the onboarding user interface for inputting data associated with the second phase of the onboarding process.

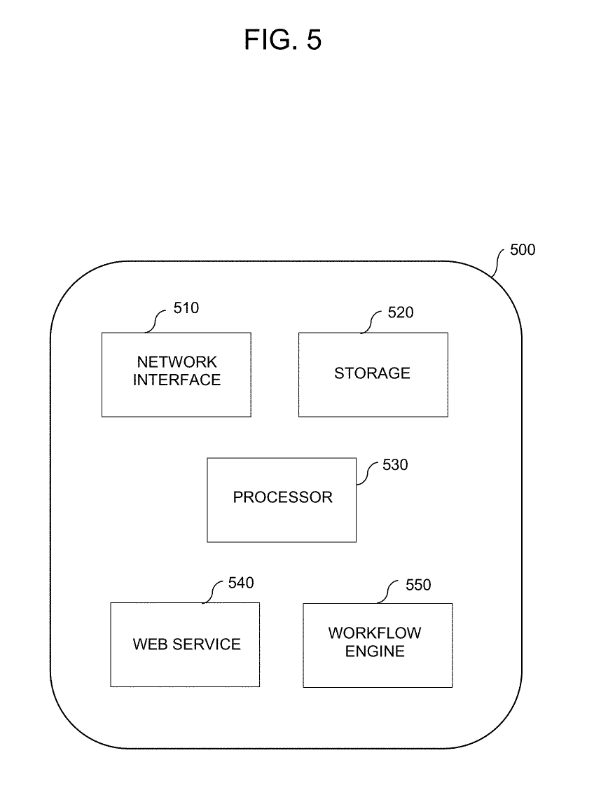

FIG. 5 illustrates a device 500 for onboarding an Internet of Things IoT application to a cloud platform in accordance with an example embodiment. For example, the device 500 may be a cloud computing device or a cloud platform. As another example, the device 500 may be a computing device such as workstation, a server, and/or the like. The device 500 may perform the method 400 of FIG. 4. Referring to FIG. 5, the device 500 includes a network interface 510, a storage 520, a processor 530, a web service module 540, and a workflow engine module 550. Although not shown in FIG. 5, the device 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 530 may include one or more processing devices each including one or more processing cores. In some examples, the processor 530 is a multicore processor or a plurality of multicore processors. Also, the processor 530 may be fixed or it may be reconfigurable. The output 530 may output data to an embedded display of the device 500, an externally connected display, a cloud, another device, and the like. The storage device 520 is not limited to any particular storage device and may include any known memory device such as RAM, ROM, hard disk, and the like. Also, the storage device 520 may include cloud storage.

In operation, the processor 520 may control the other components of the device 500. For example, the processor may execute code and/or instructions to implement the web service 540 and the workflow engine 550. The web service 540 may receive a plurality of user inputs associated with an IoT analytic application input via an onboarding user interface. In response, the workflow engine 550 may distribute the plurality of user inputs to a plurality of workstations for verifying the plurality of user inputs, receive status notifications indicating whether the user inputs have been successfully verified, and output the status notifications to a user device associated with the IoT analytic application. The plurality of user inputs may include one or more of textual data, images, spreadsheets, and code, input by the user via and the onboarding user interface and which are associated with executing the IoT application. The web service 540 may be configured to receive the plurality of user inputs by querying a database storing the plurality of user inputs previously provided from the onboarding user interface. Here, the web service 540 may perform the querying in response to receiving a request from a web application associated with the onboarding user interface.

The workflow engine 550 may be further configured to generate a process instance identification (ID) uniquely identifying the IoT analytic application and transmit the generated process ID to the web service 540. The web service 540 may use the process ID to track a status of the onboarding process of the IoT analytic application as it goes from phase to phase in the onboarding process. The workflow engine 550 may receive a notification indicating that a first phase of the onboarding process associated with a first user input has been successfully verified. The notification may be received from a stakeholder computing device or workstation. The workflow engine 550 may also transmit a notification to the user device indicating the success of the first phase and a link to a page for inputting user input associated with a second phase of the onboarding process. For example, the link may be configured to navigate a web browser of the user device to a page of the onboarding user interface for inputting data associated with the second phase of the onboarding process.

Various embodiments are directed to an onboarding portal and system for onboarding new software resources to a cloud platform. The onboarding system includes a web service and a workflow engine which control communications between a user introducing a new resource to the platform and an onboarding team that controls onboarding of new resources to the cloud platform. The web service expands the communication capabilities of the workflow engine and enables the workflow engine to receive data communications and inputs via the onboarding portal. The workflow engine controls the overall onboarding process through a plurality of phases based on user inputs and distributes the inputs to various stakeholders for processing. The workflow engine also provides the user with notifications for the next steps in the process each time a phase is successfully completed.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A method for onboarding an Internet of Things (IoT) application to a cloud platform, the method comprising:
receiving, by a web service of the cloud platform, a plurality of user inputs associated with an IoT analytic application from an onboarding user interface;
distributing, by a workflow engine of the cloud platform, the plurality of user inputs to a plurality of workstations for verifying the plurality of user inputs;
receiving, by the workflow engine, status notifications indicating whether the user inputs have been successfully verified; and
outputting, by the workflow engine, the status notifications to a user device associated with the IoT analytic application.

2. The method of claim 1, wherein the plurality of user inputs comprise one or more of textual data, images, spreadsheets, and code, input by the user via the onboarding user interface and which are associated with execution of the IoT application.

3. The method of claim 1, wherein the receiving the plurality of user inputs comprises querying, by the web service, a database storing the plurality of user inputs previously provided from the onboarding user interface.

4. The method of claim 3, wherein the querying is initiated in response to receiving a request from a web application associated with the onboarding user interface.

5. The method of claim 1, wherein the web service comprises a representational state transfer (RESTful) web service, and the method further comprises generating, by the web service, a RESTful application programming interface (API) request including the plurality of user inputs and issuing the RESTful API request to the workflow engine.

6. The method of claim 1, wherein the workflow engine comprises a business process management (BPM) platform stored on the cloud platform.

7. The method of claim 1, further comprising generating, by the workflow engine, a process instance identification (ID) uniquely identifying the IoT analytic application and transmitting the generated process ID to the web service, wherein the process ID enables the web service to track a status of the onboarding process of the IoT analytic application.

8. The method of claim 1, wherein the receiving status notifications comprises receiving a notification indicating that a first phase of the onboarding process associated with a first user input has been successfully verified, and
the outputting comprises transmitting a notification to the user device indicating the success of the first phase and a link to a page for inputting user input associated with a second phase of the onboarding process.

9. The method of claim 8, wherein the link is configured to navigate a web browser of the user device to a page of the onboarding user interface for inputting data associated with the second phase of the onboarding process.

10. A cloud computing device for onboarding an Internet of Things (IoT) application to a cloud platform, the cloud computing device comprising:
a web service configured to receive a plurality of user inputs associated with an IoT analytic application input via an onboarding user interface; and
a workflow engine configured to distribute the plurality of user inputs to a plurality of workstations for verifying the plurality of user inputs, receive status notifications indicating whether the user inputs have been successfully verified, and output the status notifications to a user device associated with execution of the IoT analytic application.

11. The cloud computing device of claim 10, wherein the plurality of user inputs comprise one or more of textual data, images, spreadsheets, and code, input by the user via and the onboarding user interface and which are associated with executing the IoT application.

12. The cloud computing device of claim 10, wherein the web service is configured to receive the plurality of user inputs by querying a database storing the plurality of user inputs previously provided from the onboarding user interface.

13. The cloud computing device of claim 12, wherein the web service performs the querying in response to receiving a request from a web application associated with the onboarding user interface.

14. The cloud computing device of claim 10, wherein the web service comprises a representational state transfer (RESTful) web service that is configured to generate a RESTful application programming interface (API) request including the plurality of user inputs and issuing the RESTful API request to the workflow engine.

15. The cloud computing device of claim 10, wherein the workflow engine comprises a business process management (BPM) platform stored on the cloud platform.

16. The cloud computing device of claim 10, wherein the workflow engine is further configured to generate a process instance identification (ID) uniquely identifying the IoT analytic application and transmit the generated process ID to the web service, wherein the process ID enables the web service to track a status of the onboarding process of the IoT analytic application.

17. The cloud computing device of claim 10, wherein the workflow engine is configured to receive a notification indicating that a first phase of the onboarding process associated with a first user input has been successfully verified, and transmit a notification to the user device indicating the success of the first phase and a link to a page for inputting user input associated with a second phase of the onboarding process.

18. The cloud computing device of claim 17, wherein the link is configured to navigate a web browser of the user device to a page of the onboarding user interface for inputting data associated with the second phase of the onboarding process.

19. A non-transitory computer readable medium having stored therein instructions that when executed cause a computer to perform a method for onboarding an Internet of Things (IoT) application to a cloud platform, the method comprising:
receiving, by a web service of the cloud platform, a plurality of user inputs associated with an IoT analytic application from an onboarding user interface;
distributing, by a workflow engine of the cloud platform, the plurality of user inputs to a plurality of workstations for verifying the plurality of user inputs;
receiving, by the workflow engine, status notifications indicating whether the user inputs have been successfully verified; and
outputting, by the workflow engine, the status notifications to a user device associated with the IoT analytic application.

20. The non-transitory computer readable medium of claim 19, wherein the receiving the plurality of user inputs comprises querying, by the web service, a database storing the plurality of user inputs previously provided from the onboarding user interface, and
the querying is initiated in response to receiving a request from a web application associated with the onboarding user interface.
